(19) United States
(12) Patent Application Publication
(10) Pub. No.: US 2015/0197656 A1
(43) Pub. Date: Jul. 16, 2015

(54) Method for Producing Emulsion Paints

(71) Applicant: HEMMELRATH TECHNOLOGIES GmbH, 63911 Klingenberg (DE)

(72) Inventor: Ralf Hohmann, Grossheubach (DE)

(73) Assignee: HEMMELRATH TECHNOLOGIES GmbH, Erlenbach (DE)

(21) Appl. No.: 14/416,062

(22) PCT Filed: Jul. 19, 2013
(86) PCT No.: PCT/DE2013/100271

§ 371 Date: Jan. 21, 2015

(30) Foreign Application Priority Data
Jul. 27, 2012 (DE) 10 2012 015 022.9

(51) Int. Cl. C09D 105/00; B01F 3/08; B01F 7/00; C09D 101/28

(52) U.S. Cl. CPC C09D 105/00; C09D 101/28; C09D 101/284; B01F 3/0807; B01F 7/00; B01F 2215/005

(57) ABSTRACT

The invention relates to a method for producing emulsion paint using admixtures such as fillers, pigments, additives, dispersing agents, de-foaming agents, film binding aids, preservatives, as well as cellulose ethers and/or xanthanes as thickeners and binding agents, wherein the processing time in the form of mixing and blending the cellulose ethers and/or xanthanes with the other admixtures present in the aqueous phase is shorter than the swelling time of the cellulose ether and/or xanthanes.

The invention relates to a method for producing emulsion paint using admixtures such as fillers, pigments, additives, dispersing agents, defoaming agents, film-binding aids, preservatives, as well as cellulose ethers and/or xanthans as thickeners and binders.

The aim is to create emulsion paints that are characterized by a high thickening performance, good storage stability and easy processing, and environmentally friendly application. Furthermore, the products should show uniformly good applications properties in different formulations, that is to say low tendency to splash, good paint surface, ease of spreading, high abrasion resistance, good pigment distribution and the like. In addition, it should be possible to produce the emulsion paint, in terms of process technology, rapidly, simply and cost effectively.

Emulsion paints, as with all water-thinnable coating agent systems, consist of coating materials in the form of binders, fillers, pigments, additives and water, and cellulose ethers are, as is known, added as thickening agents. Apart from their thickening effect, these cellulose ethers also have a positive influence on the stabilization, the flow behavior and the water retention of the emulsion paints. The cellulose ethers are therein suitable for emulsion paints of conventional composition which may contain binders, for example polyvinyl acetate, polyvinyl propionate and styrene acrylate, pigments, for example titanium dioxide, barium sulphate and zinc sulphide, the fillers, for example calcium carbonate, calcium sulphate, quartz, kaolin, china clay and talc, additives, for example wetting agents and dispersing agents such as polyphosphate and polyacrylates, defoamers, for example mineral-oil-based product, film-forming agents, for example white spirit and butyl carbitol acetate and conservation agents, for example phenolic compounds and organic amides, are generally familiar.

The term “thickening agent” is to be generally interpreted in the sense of the invention and usually describes high-molecular substances that absorb liquids, usually water, and in the process swell and are ultimately transformed into viscous genuine or colloidal solutions, and which are often also termed swelling agents (see Römpp Chemie Lexikon, 9th edition, Georg Thieme Verlag, keyword “Verdickungsmittel”). Xanthans, too, which are, as is known, used as thickening agents and stabilizers for emulsions in paint production. This is a glucose compound that is produced by microbial cultures based on carbohydrates. After killing of the cultures, the desired xanthans are obtained. As regards its chemical composition, it is cellulose, consisting of a chain of bound glucoses with side chains and which, as regards its properties, is determined by the structure of the subgroups, the number of pyruvate units determining the viscosity of the xanthan.

The thickening effect of cellulose grades in water or water-thinnable binders and paints is to be examined in closer detail. As for all high-molecular polymers, it is generally the case that the thickening effect in water increases with the molecular weight. The production of high-molecular celluloses, however, is limited by the nature of the starting materials, for example the pulps. To obtain water-swellable, and thereby thickening celluloses, hydrophobisation is necessary, which, in general, is produced by etherification, and, in the most frequent cases, also leads to molecular weight depressions by virtue of side reactions. It is therefore known in the prior art, by means of polymer-analogous reactions, for example cellulose compound modified by, for example, etherification, to generate low-molecular celluloses that produce high-viscosity solutions in water. Such modified cellulose ethers have a high surface activity and can be used to produce viscous aqueous solutions.

With the addition of the water-soluble cellulose ethers, whether in solid powder form or in aqueous suspension, problems often occur in breaking up these thickening agents with no lumps and dispersing them so as to achieve a rapid and uniform solution until the eventual viscosity build up. Different measures are known, which in principle come down to preventing or delaying the swelling of the surface of the cellulose ether particles (powder, granules or agglomerates) by the action of water molecules until the particles are uniformly distributed in the water-containing emulsion paint. An overview of the multiplicity of measures already taken can be seen in German Offenlegungsschrift DE OS 3232467, the gist of which consists in, by reacting the cellulose or cellulose ether with different chemical compounds, to achieve a modification of the solubility properties in order to obtain an improvement.

The behavior of cellulose ether in aqueous solutions is essentially determined by the pH. At a pH of below 7.5, no swelling reaction of the cellulose ether takes place; on an increase of the pH with a transition range of about pH 8, the breakdown of the cellulose ether occurs, so that it fulfills its function as a thickening agent. The normal procedure in the production of emulsion paint is, at a pH of 7 (or below), to scatter the cellulose ether into the aqueous solution as a powder or suspension, to disperse it homogeneously by mechanical stirring and then subsequently, by addition of alkali, to raise the pH so that the breakdown of the cellulose is initiated and a homogenous mixture occurs, which can fulfil its function as thickening agent. If the cellulose ether were added to an already alkaline aqueous solution, the cellulose ether would be immediately broken down, however, disadvantageously, lumps and clumps would form, which cannot be adequately finely divided with conventional processing technology and lead to a pimply surface on application, which can no longer be eliminated. Consequently the emulsion paint would be unusable.

Another problem consists in adding the further admixtures to the high-viscosity solution that has been broken down by the thickening agent and dispersing them, which is very energy intensive and difficult. A key problem comes from the fact that, with addition of the admixtures, the pH rises to 9 and consequently the cellulose immediately begins to swell, so that the addition of the cellulose ether at the beginning of the process is forbidden.

The object of the present invention is to propose a production process for emulsion paints using cellulose ethers and/or xanthans as thickening agents, which can be incorporated without lumps.

This object is achieved according to the invention in that the processing time in the form of mixing and blending the cellulose ether and/or xanthans with the other admixtures present in the aqueous phase is shorter than the swelling time of the cellulose ether and/or of the xanthans.

For the success of the method according to the invention, it is crucial that, on addition of the thickening agent, the technological processing speed is lower than the swelling time (reaction time) of the cellulose ether, so that a mixing and blending is readily possible despite the already incipient swelling process. The processing time is thus shorter than the swelling time. As a measure of the swelling of the cellulose, the corresponding viscosity state, which can be very readily registered by instrumentation, can be used. In principle, the swelling process proceeds proportionally to the rise of the viscosity. It is decisive for describing the swelling process that I can ascertain that when, starting from the original material, the viscosity has increased by a factor, the swelling operation is concluded. It is possible to give the viscosity in figures, since generally applicable yardsticks exist for this The increase could by described by a percentage figure, that is to say that the process is concluded when the viscosity has increased by a factor of X. According to the requirement of the invention, the swelling time (reaction time) of the cellulose ether must be bigger than the processing time of the thorough mixing and admixing during the processing phase. The processing speed must take place so fast and/or the swelling time of the cellulose must take place so slowly that no lumps and clumps can form. The monitoring of the freedom from lumps and clumps takes place in that an extract on a glass surface is produced and after it has run down, it is determined whether lumps remain or whether a completely smooth surface is present. For this purpose, the paint is applied to a glass plate and allowed to run down, a greater thickness being established below than higher up. The thinner the coat is, the more selective and smaller are the clumps, which can be identified because, in the case of an excessive diameter, they project outwardly above the surface and are recognised as unevennesses. In this test method it can be reliably ascertained that the layer is chosen so thin that, on subsequent application by the customer, the layer (of the coat) is higher than this, so that the appearance of a smooth surface is ensured. Due to these measurement values, which monitor the production process, it can be ascertained whether the manufacturing process is operated in the sense of the invention. Process parameters, in an absolute sense, cannot be quoted due to the multiplicity of the parameters acting on the manufacturing process. For example, the capability for wetting the solid particles has a decisive influence, which depends on the choice of the corresponding liquid but also on with which viscosity the liquid is used, since thin liquids are better at wetting. Also, the materials themselves must not only be in principle wettable, but the greater the relative surface area of the material is, the better it can be wetted.

The freedom from lumps of the finished “emulsion paint” end product means that the maximum grain sizes contained in the end product come to lie below a particular limit. The maximum grain size depends essentially on the requirements of the subsequent application and is determined by the setting of the parameters of the production process. In the case of emulsion paints, a freedom from grains of even below 50 pm is often and generally required, and we thereby also require it here, in which case, in the sense of the invention, the term freedom from lumps is used.

Based on experimental experiences, it is known that the time available for the swelling and processing varies in the range of milliseconds ms.

In the methods of the prior art, the admixtures are dispersed in in the high-viscosity consistency. In our case, the further solids are introduced into the aqueous phase, where they can be readily dispersed. Therein lies one of the essential differences of the method according to the invention from the prior art. It does not require further justification that the addition to an aqueous phase considerably simplifies the dispersion, which results in a crucial advantage that the energy outlay to be performed during dispersion is considerably lower compared to the prior art. Due to the possibility of better dispersion, a further considerable advantage can be seen in the fact that the use and exploitation of the components to be added can take place significantly more efficiently. Due to the different rheological behaviour, the difference in the energy outlay to be provided is considerable.

A significant embodiment of the invention consists in the fact that the production of the emulsion paint takes place in a two-stage process. Thus, a semifinished product can be produced, which can be used at a different time, at a different place, for the final production of the emulsion paint It is thus possible to market this semifinished product and the customer produces the end product himself on the spot. For this purpose, the invention proposes concretely, that all solids, pigments, admixtures and the like, that is to say all the ingredients contained in the emulsion paints, but with the exception of the binders and thinners, are introduced into an aqueous phase and blended. In the second step, that is to say locally, the missing components, namely cellulose ether and binders, are admixed corresponding to the present invention.

A considerable advantage is that a semifinished product can be produced, that is to say all solids and pigments (with the exception of binders and thickeners) are contained in an aqueous phase, which is universally applicable. This is not feasible with processes of the prior art, because insufficient free water is available, since it would be bound to the cellulose ether. This water is then lacking in the last production step, in which the entire product is mixed together from the semifinished product. In the proposed solution, at the beginning of the production process, water is saved, since it cannot be absorbed, since the cellulose is not present. Such a semifinished product cannot be produced by the prior art as a result of the lack of water. The further procedure is as follows: Into this semifinished product, the cellulose ether is then introduced and the binder is stirred in and the end product is thus completed. The customer obtains, by means of the semifinished product, the essential components, and it is made possible for him to purchase the components necessary for completing the end product (cellulose, binders) from a different source and then to process them in the sense of the invention. This semifinished product and/or the possible procedure is not possible in the prior art.

A crucial further advantage consists in the fact that, with the method according to the invention, a considerably improved basic dispersion is possible and thereby the production of smoother surfaces. In addition, the degree of exploitation of the raw materials is considerable because dispersion in the viscous state is difficult. The advantage of the semifinished product results from the fact that the necessary water is present, which is only possible due to the fact that the cellulose ether is only added at the end.

The semifinished product is free of thickeners and binders and can therefore be marketed, since this otherwise would not be possible, or would be relatively unacceptable, in principle due to the high viscosity. There are a plurality of reasons for this:

As semi-finished product, the already completely blended paint is available, so that the solids must no longer be dispersed to the extent that would otherwise be necessary due to the high viscosity. That is only possible if the water equilibrium is adjusted correspondingly, which presupposes that the thickener is not contained because it binds any amount of water, which, ultimately, is also the point of the thickening agent.

In an alternative, the solids contained in the semifinished product can be supplied as a solid mixture, which the customer must mix with water, so that the water does not need to be transported.

A financial aspect is also significant. The substance broken down by the cellulose ether provides the property of a high-viscosity paste-like consistency. The provision of the emulsion paint as complete delivery, however without binder, means that the high-viscosity consistency would have to be transported, so that, in economic terms, and because of the same outlay, the finished emulsion paint can also be delivered directly.

If a solid mixture containing all components were to be delivered and it is required that it is introduced into the high-viscosity consistency, this is only possible with extremely high outlay due to the consistency.

Another aspect consists in the fact that, if the solid components are broken down and singular slurries are produced, which are subsequently mixed, for example, according to the discretion of the user, it does not lead to the goal since, because of the recipe structure, each slurry contains a great deal of water, which as a result produces a very low-viscosity consistency, which is not suitable as paint, or considerable amounts of thickening agents much be added, which would not be economically acceptable.

The aim is to produce a clump-free and lump-free mixture. It is not just a matter of the mixing and dispersion, but also of the chemical reaction, that is to say I must achieve a swelling, but, on the other hand, no lumps or clumps must be left behind. That is only possible with the factor of time, which lies within the ms range. By “chemical reaction” is to be understood the swelling, which here would be precisely termed a physicochemical reaction.

For the thorough mixing of solid and liquid components, the use of a dissolver is considered as obvious. The amount of energy to be supplied can, in the case of a dissolver, be varied as desired by setting the rotational velocity. The dispersion is determined according to the amount of dispersion energy that is supplied, which, is measured with respect to time but also by means of the dispersion rate. If a powder is introduced, the individual powder grains are compressed particles which must be broken apart and comminuted, for which energy input is required. But it is not just a matter of the supplied energy, since a majority—up to 90% in the case of a dissolver—is converted into thermal energy. Ultimately, it is a question of the useful energy, that is to say that energy that is applied for dispersion (it corresponds to the efficiency). The process must also take place within a certain time span. Only the combination leads to the goal.

### MODE OF OPERATION OF A DISSOLVER

On actuation, the liquid forms a thrombus, into which the solid is poured. The cause of this is that the dissolver executes a rotational movement centrically. The supplied solid particles are flung against the edge and onto the wall, where they are sheared with the aid of the dissolver disc. Since we are working in a high-viscosity medium, a great deal of energy must be supplied, which for the most part is converted into heat and leads to a rise of the temperature, which in turn lowers the viscosity, so that two contradictory parameters occur. The action time of the dissolver in relation to the temperature gradient takes some minutes. The object is to supply as much energy as possible and to keep the temperature low, which can only be established and regulated over time.

According to Römpp Chemie Lexikon, the term “binder” is a generic term for all products that combine the same or different substances, whereby the setting itself may take place in different ways, for example by physical drying, by solidification or viscosity rise, by chemical reactions or by hydration. Due to the above-described reaction mechanisms, a clear distinction of the binders from the thickening agents can be made. In particular the cellulose ethers used as thickening agent cannot be regarded as binders in the sense of this invention.

Due to the fact that the present invention is concerned with the production of emulsion paints, it is of decisive advantage that, as binder, a film-forming agent is used, which, after the production of the coating, gives rise to the production development and creation of a coating film. Here, the use of an independent film-forming agent is preferred, which is capable of developing a coating film alone, that is to says without the addition of further substances with or without the influence of oxygen. In the case of non-independent film-forming agents, on the other hand, a development of the coating film is only possible in the presence of further components, that is to say only with the application of suitable mixtures.

Experiences show that even with optimization of all process parameters, the use of a dissolver requires a time outlay in the range of seconds. The time needed according to experience of a few milliseconds cannot be adjusted easily in this way. It is therefore appropriate to use other devices, for example those that operate by the rotor-stator principle, in which the material to be dispersed is taken in via a pump and is dispersed and wetted in a few milliseconds. By the “rotor-stator” principle is described the mode of operation of all those dispersion units that operate by the centrifugal principle. Due to the movement of the rotor, a vacuum forms, via which the solids and also the liquids are sucked in in an axial direction by the rotor. With a sufficiently high vacuum, the powder is distributed without additional conveying air being necessary. It is to be seen as a further advantage, that the air molecules adhering to the powder, which can be registered in a weight difference between the bulk weight and the specific weight, are separated during the wetting operation, The result is a virtually air-free product. The separation of the air and the complete forced wetting of the solid particles takes place in the vacuum region of the dispersion zone.

However, the performance of the manufacturing process according to the invention is not restricted to particular action principles, but all devices can be used that are capable of realising the process parameters according to the invention.

In advantageous embodiments, from the group comprising hydrophobised cellulose ethers, in particular methylcellulose (MC), methyl hydroxyethyl cellulose (MHEC), methyl hydroxylpropyl cellulose (MHPC), hydroxyethyl cellulose (HEC) and ethyl hydroxyethyl cellulose (EHEC) are to be mentioned.

It is particularly preferred in the execution of the method according to the invention to add first the thickening agent and subsequently, that is to say after a time delay, the binder. The advantages obtained thereby consist first therein that the thickening agent, in the case in which no lumps are present, can be considerably better finely dispersed during the subsequent mixing, for example in the rotor-stator system than in the case in which binder is present, which counteracts the fine dispersion. Another important aspect consists in the fact that the binder is often not shearing-stable, so that disadvantages are to be expected during processing of the thickening agent - since the binders would already be present. If, on the other hand, the binder is added subsequently, it can be stirred in or introduced gently. This would be the last step in the production of the emulsion paint.

For a further illustration, a concrete exemplary embodiment of the method according to the invention is described below.

In a batching tank, water is added introduced as liquid charge. A plurality of admixtures are charged into a batching tank in each case. The temperature is 9° C., Subsequently all powders are accommodated in a powder hopper, where they are mixed together by means of the Conti-TD dispersion unit, which operates by the rotor-stator principle. Finally, water and other components are added. Dispersion with the Conti-TDS dispersion unit and a jet-stream mixer takes place.

It is of crucial important for the invention that the cellulose is subsequently also fed via the dispersion unit and homogenized. The performance is 85-90 kW for a machine speed of 3,600 rpm. Subsequently caustic soda is fed in to purge the powder path of cellulose. Subsequently, a recirculating dispersion of the Conti-TDS dispersion unit with the power of 85-90 kW and a speed of 3,600 rpm takes place.

Finally as last production step, binder is added and mixed in. The feeding of powder and liquids into the dispersion unit takes place via the FSA-5 fluidizer.

The filling of the paint into the appropriate containers remains.

The production parameters of a special production process for emulsion paint according to the invention can be taken again from the following overview and thereby further explained.

| | | Power | Speed | Temp. | |
|---|---|---|---|---|---|
| Time | Comment | kW | rpm | ° C. | Sample |
| | Liquid charge, addition of water to batching | | 250 | 9.0 | |
| | tank, switch-on of jet-stream mixer | | | | |
| | Addition of additive 1 to batching tank | 0.3 | 350 | | |
| | Homogenization with jet-stream mixer | | | | |
| | Addition of additive 2 to batching tank | 0.3 | 350 | | |
| | Homogenization with jet-stream mixer | | | | |
| | Addition of additive 3 to batching tank | 0.3 | 350 | | |
| | Homogenization with jet-stream mixer | | | | |
| | Addition of additive 4 to batching tank | 0.3 | 350 | | |
| | Homogenization with jet-stream mixer | | | | |
| | Sample measurement pH | | | | |
| | Charging of all powders in large powder | 70 | 3,600 | 16 | |
| | hopper; Feeding of the solids and fillers via | 1.2 | 650 | | |
| | Conti-TDS and FSA5 fluidizer into the | | | | |
| | batching tank, homogenization with | | | | |
| | jet-stream mixer | | | | |
| | Addition of water | | 650 | | |
| | Homogenization with jet-stream mixer | | | | |
| | Addition of additive 4 to batching tank | | 650 | | |
| | Homogenization with jet-stream mixer | | | | |
| | Addition of additive 5 to batching tank | | 650 | | |
| | Homogenization with jet-stream mixer | | | | |
| | Addition of additive 6 to batching tank | | 650 | | |
| | Homogenization with jet-stream mixer | | | | |
| | Recirculating dispersion with Conti-TDS | 80-82 | 3,600 | 20 | |
| | dispersion unit and jet-stream mixer at 20° C. | 1. | 650 | | |
| | Sample measurement of pH | | | | |
| | Feeding of the cellulose via the 2nd powder | 85-90 | 3,600 | | |
| | route with an additional powder hopper and | 6.6 | 650-12 | | |
| | Conti-TDS, homogenization with jet-stream | | 50 | | |
| | mixer | | | | |
| | Feeding of caustic soda via the 2nd powder | | | | |
| | route (purging of the powder route of | | | | |
| | cellulose) and Conti-TDS, homogenization | | | | |
| | with jet-stream mixer | | | | |
| | Recirculating dispersion with Conti-TDS | 85-90 | 2,600 | 45 | |
| | dispersion unit and jet-stream mixer up to | 5.0- | 1,050- | | |
| | 45° C. | 7.5 | 1,250 | | |
| | Addition of binders in batching tank | | 1,250 | | |
| | homogenization by means of jet-stream | | | | |
| | mixers | | | | |
| | Filling into containers/end | | | | |

1. Method for producing emulsion paint using admixtures such as fillers, pigments, additives, dispersing agents, defoaming agents, film binding aids, preservatives, as well as cellulose ethers and/or xanthans as thickeners and binders, wherein the processing time in the form of mixing and blending the cellulose ether and/or xanthan with the other admixtures present in the aqueous phase is shorter than the swelling time of the cellulose ether and/or xanthans.

2. Method according to claim 1, wherein the binder is a film-forming agent, in particular an independent film-forming agent.

3. Device for performing the method according to claim 1 or 2, characterized that a device that operates according to the rotor-stator principle is used for mixing the cellulose ether and/or xanthans.

4. Method according to claim 1, wherein, as cellulose ether, methylcellulose (MC), methyl hydroxyethyl cellulose (MHEC), methyl hydroxylpropyl cellulose (MHPC), hydroxyethyl cellulose (HEC) and/or ethyl hydroxyethyl cellulose (EHEC) are used.

5. Semifinished product for performing the method according to claim 1, wherein all components of the emulsion paint, with the exception of the thickening agent and binder, are present in the aqueous phase as suspensions.

6. Semifinished product for performing the method according to claim 1, wherein all components of the emulsion paint, with the exception of the thickening agent and binder as well as water, are present as solid components.

7. Use of the semifinished product according to claim 5, wherein thickening agents and binders are admixed to the semifinished product, if appropriate after the addition of water, corresponding to the method according to claim 1.

8. Method according to one of claim 7, wherein the binder is added chronologically after the thickening agent.
